(19) United States
(12) Patent Application Publication
(10) Pub. No.: US 2017/0169018 A1
(43) Pub. Date: Jun. 15, 2017

(54) Method and Electronic Device for Recommending Media Data

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Xingwei HE, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,161

(22) Filed: Aug. 19, 2016

Related U.S. Application Data
(63) Continuation of application No. PCT/CN2016/088833, filed on Jul. 6, 2016.

(30) Foreign Application Priority Data
Dec. 9, 2015 (CN) 201510908059.5

(51) Int. Cl. G06F 17/30

(52) U.S. Cl. CPC G06F 17/30038; G06F 17/3053; G06F 17/30241; G06F 17/30598

(57) ABSTRACT

The present disclosure discloses a method and an electronic device for recommending media data, the method includes: generating a regional feature vector of each region; receiving an instruction for obtaining recommended content; obtaining user information, historical access data and location information of a target user; forming an alternative media data group; scoring interest popularity of the target user on the media data in the alternative media data group; obtaining the regional feature vector related to the location information of the target user; performing regional information scoring on the media data in the alternative media data group; obtaining a comprehensive score of the media data in the alternative media data group by combining the interest popularity score of the target user with the regional information score; and recommending a plurality of media data with top ranked comprehensive scores to the target user.

### CROSS-REFERENCE TO RELATED APPLICATION

This disclosure is a continuation of International Application No. PCT/CN2016/088833, with an international filing date of Jul. 6, 2016, which claims the benefit of Chinese Patent Application No. 201510908059.5 filed on Dec. 9, 2015 titled “METHOD AND SERVER FOR RECOMMENDING MEDIA DATA”, both of which are incorporated herein by reference in their entireties.

### TECHNICAL FIELD

The present disclosure relates to the field of data analyzing and processing technologies, and in particular, to a method and an electronic device for recommending media data.

### BACKGROUND

Various portal web sites, news APPs and the like will display various news information on the home page or a preview interface of a lower-level classification menu, however such news information is generally sequenced and recommended in a time sequence, thus no individualized content is recommended for a user. Moreover, for a video player software, videos are generally recommended to a user according to the time sequence or the number of clicks. For some better software, some videos which a user may be interested in will be recommended according to the historical record of the user; however, this is not enough to meet the real demand of a user.

### SUMMARY

Therefore, the present disclosure provides a method and an electronic device for recommending media data, thereby a specific user can be well recommended with media data that may better meet the real demand thereof.

According to a first aspect, an embodiment of the disclosure provides a method for recommending media data, which is applied to a server, wherein, the method includes:

Generating a regional feature vector of each region based on user information and historical access data of a regional user;

Receiving an instruction for obtaining recommended content sent by a target user;

Obtaining user information, historical access data and location information of the target user;

Grasping a plurality of media data related to an interest of the target user from a media database according to the historical access data of the target user to form an alternative media data group;

Performing interest popularity scoring of the target user on the media data in the alternative media data group according to the historical access data of the target user;

Obtaining a regional feature vector related to the location information of the target user according to the location information of the target user;

Performing regional information scoring on the media data in the alternative media data group by utilizing the regional feature vector related to the location information of the target user;

Obtaining a comprehensive score of the media data in the alternative media data group by combining the interest popularity score of the target user with the regional information score; and

Recommending a plurality of media data with top ranked comprehensive scores to the target user.

According to a second aspect, the embodiment of the present disclosure provides a non-volatile computer-readable storage medium stored with computer executable instructions, the computer executable instructions perform any one of the method described above in the disclosure.

According to a third aspect, the embodiment of the present disclosure provides an electronic device, including: at least one processor; and a memory; wherein, the memory is communicably connected with the at least one processor for storing instructions executed by the at least one processor, the computer executable instructions perform any one of the method described above in the disclosure.

### BRIEF DESCRIPTION OF THE DRAWINGS

One or more embodiments are illustrated by way of examples, and not by limitation, in the figures of the accompanying drawings, wherein elements having the same reference numeral designations represent like elements throughout. The drawings are not to scale, unless otherwise disclosed.

FIG. 1 is a schematic flow chart of an embodiment of the method for recommending media data according to the disclosure;

FIG. 2 is a schematic flow chart of another embodiment of the method for recommending media data according to the disclosure;

FIG. 3 is a schematic diagram showing the module structure of an embodiment of the server for recommending media data according to the disclosure;

FIG. 4 is a schematic diagram showing the module structure of a regional feature vector generating module in an embodiment of the server for recommending media data according to the disclosure;

FIG. 5 is a schematic diagram showing the structure of a media data classification tree in an embodiment of the method and the server for recommending media data according to the disclosure; and

FIG. 6 is a schematic diagram showing the structure of media data classification tree with features mined in an embodiment of the method and the server for recommending media data according to the disclosure; and

FIG. 7 is a structural schematic of an electronic device provided by an embodiment of the present disclosure.

### DETAILED DESCRIPTION

The embodiments, of which the examples are shown in the drawings, will be illustrated in detail here. When the description below is related to the drawings, the same number in different the drawings represents the same or similar element, unless otherwise expressed. The implementations described in the following exemplary embodiments do not represent all the implementation consistent with the disclosure. Instead, they are only examples of the device and the method consistent with some aspects of the disclosure as described in detail in the claims appended.

In order to make the objects, technical solutions and advantages of the disclosure more apparent, the disclosure will be further illustrated in detail below in conjunction with specific embodiments and referring to the drawings.

It should be noted that, in the embodiments of the disclosure, the purpose of the use of the expression “first” and “second” is to distinguish between two different entities or different parameters with the same name. Thus, it may be seen that “first” and “second” are only used for convenient expression, rather than limiting the embodiments of the disclosure, which will not be illustrated again in the subsequent embodiments.

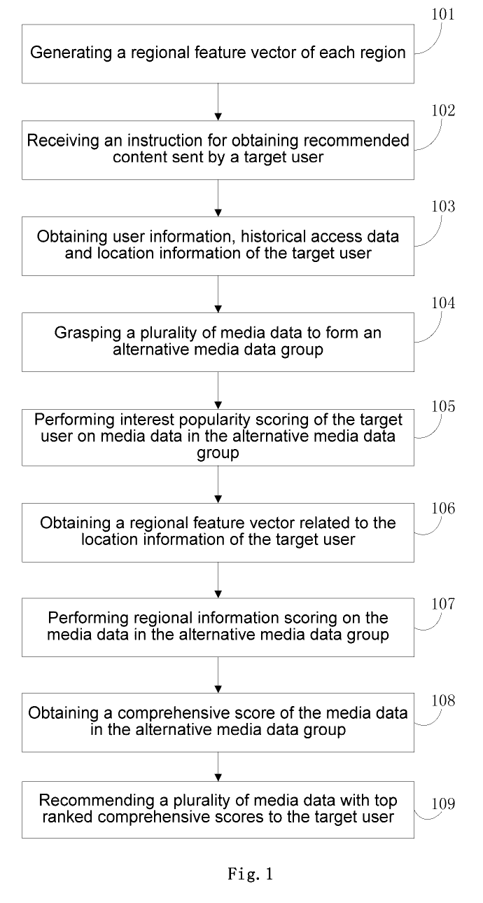

In a first aspect of the embodiments of the disclosure, there provides a method for recommending media data, by which a specific user can be well recommended with media data that may better meet the real demand thereof. As shown in FIG. 1, it is a schematic flow chart of an embodiment of the method for recommending media data according to the disclosure.

The method for recommending media data, which is applied to a server (especially, a server for recommending media data), includes the following steps.

In step 101, a regional feature vector of each region is generated based on user information and historical access data (the data source is a log) of a regional user.

Here, the user information and the historical access data of the regional user refer to the user information and the historical access data of all or a part of the nationwide users (the data volume needs to be large enough for cluster algorithm); the region generally refers to a prefecture city-level region, of course, it may be a county-level city or a county, but the statistical meaning of county is very small, and it is statistically enough for prefecture city; the regional feature vector refers to a vector including a plurality of features representing the interest hot spot of the users in this region that may be statistically obtained from the user group in this region; the regional feature vector embodies the tendency attributes and weights of some interests in each region, and the value in each regional feature vector is usually different, which embodies an aggregation of people's interests in each region.

In step 102: an instruction for obtaining recommended content sent by a target user is received.

That is, a certain specific user opens a certain portal web site (or a lower-level classification menu thereof, for example, football) or a certain video player software (or a lower-level classification menu thereof, for example, football), because a homepage or a lower-level menu page needs to be exhibited, an instruction for obtaining recommended content is sent to the server, and the instruction is received by the server.

In step 103: user information, historical access data and location information of the target user are obtained.

Wherein, the user information includes user ID, user level (an VIP or not), etc.; the historical access data includes the near-term watching and viewing historical record data of a user, etc.; the location information is the current geographic location of a user, the location information may be obtained via the IP address of the computer of the user or the GPS positioning of the mobile phone of the user, etc.

In step 104: a plurality of media data related to the interest of the target user are grasped from a media database according to historical access data of the target user to form an alternative media data group.

A plurality of near-term interest hot spots (for example, football and American film and play, etc.) of the target user can be statistically obtained from the historical access data of the target user, and media data related to the corresponding interest hot spot may be grasped from the media database according to each interest hot spot, the number of media data grasped for each interest hot spot is in a range of 50˜500, and usually about 200; and the media data groups grasped based on each interest hot spot are synthesized into an alternative media data group.

In step 105: interest popularity scoring of target user is performed on each media data in the alternative media data group according to historical access data of the target user.

That is, different popularity of each interest hot spot of the target user is obtained according to the historical access data of the target user; for example, in the past 30 days, the target user browsed the classification “football” for 40 times and browsed classification “American film and play” for 20 times, then the popularity of “football” is about twice of the popularity of “American film and play”. However, this is only an example, the popularity may also be calculated via staged popularity calculation according to the time at which the interest hot spot appears (for example, media data appearing at a time far from the current time will be de-weighted over time), then the interest popularity score of the target user of each media data is obtained according to the popularity.

In step 106: the regional feature vector related to the location information of the target user is obtained according to the location information of the target user; for example, the current location information of the target user is a certain building in Zhongguancun, Haidian District, Beijing City, then the regional feature vector corresponding thereto will be the regional feature vector corresponding to Beijing City.

In step 107: regional information scoring is performed on each media data in the alternative media data group by utilizing the regional feature vector related to the location information of the target user; that is, a similarity between the feature vector of the media data and the regional feature vector is calculated, and a regional information score is obtained via the similarity.

In step 108: a comprehensive score of each media data in the alternative media data group is obtained by combining the interest popularity score of the target user with the regional information score.

In step 109: a plurality of media data with top ranked comprehensive scores are recommended to the target user.

It may be seen from the above embodiment that, in the method for recommending media data according to the embodiment of the disclosure, first of all, regional users are divided according to regions, a regional feature vector is obtained based on the user data in the region, the corresponding media data is grasped based on the historical access data of the target user when an instruction for obtaining recommended content sent by a certain target user is received, target user interest hot spot scoring is performed on these media data, the corresponding regional feature vector is obtained according to the location information of the target user, a regional information score is calculated, a comprehensive score is obtained by combining the two kinds of scores, and media data is recommended to the target user according to the sequencing of comprehensive scores. Therefore, when media data are recommended to the target user, the media data can not only be recommended according to the interest hot spot of the target user, but also be recommended in conjunction with the group hot spot of the region in which the target user locates, thereby the effect of more accurately recommending media data to a target user may be realized.

For each region (for example, Beijing City), it is regarded as a special object, and this object has some basic features, the information of this region is described via a feature vector. The features that “Beijing City” has are not simply set manually; instead, it is a model trained commonly according to a classification system and data mining based on all user data in Beijing.

Therefore, in some optional implementation, the step 101 of generating a regional feature vector of each region based on user information and historical access data of a regional user (this step may be accomplished off line in advance) may further include the steps of:

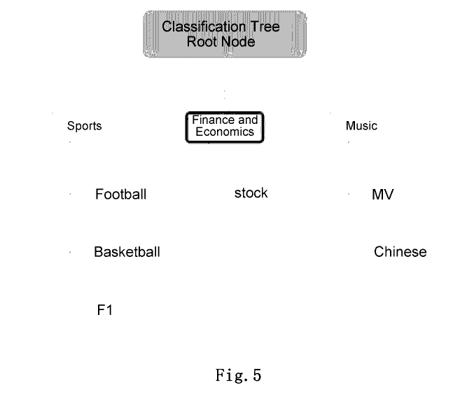

A preset media data classification tree (the structure chart of the classification tree comes from a preset configuration file) is obtained; wherein, the media data classification tree is set in advance, and the subclassification such as lower-level classification and next lower-level classification, etc., is set in advance; as shown in FIG. 5, it is hypothesized that media data classification tree includes sports, finance and economics and music as first-level classification (that is, channel, and the weight value of the first-level classification only acts on a new user), and sports has football, basketball and F1 as second-level classification;

The user information and the historical access data of the regional user are obtained;

The user information and the historical access data of the regional user are divided according to regions to form regional user data groups;

Feature obtained training is performed on each regional user data group respectively according to structure of the media data classification tree; and

A regional feature vector corresponding to each region is obtained from the feature obtained training result generated.

By performing feature obtained training via the structure of media data classification tree, overfitting can be well prevented, thus the influence of noise feature data on the effective data may be avoided effectively.

Moreover, in some implementation, the step of training each regional user data group respectively according to the structure of the media data classification tree includes:

The media data in the regional user data group are classified according to the media data classification tree; that is, first of all, the media data are assigned to each classification of the media data classification tree corresponding to the feature thereof; this step may prevent overfitting well by preliminarily pre-classifying the media data;

A classification feature of the lowest subclassification is mined and obtained from the media data of the each lowest subclassification via a cluster algorithm; because the media data classification tree only includes a preliminary classification structure, the specific features therein need to be mined via a cluster algorithm; and

A feature obtained training result is obtained by combining the media data classification tree with the classification feature of each lowest subclassification thereof.

Wherein, according to the results of classifying and clustering, the weight of the corresponding feature may also be obtained. The process of feature obtained training will be introduced below via an example.

1) It is hypothesized that “Beijing City” contains 1 million people and these people only watch two types of media data, among these 1 million people, 800 thousand people often watch sports-type media data and 500 thousand people often watch finance and economics-type media data (wherein, 300 thousand people watch both); by data analysis, the features of the object “Beijing” may be divided into two major classifications (sports, finance and economics), and it may be obtained that: feature_sports=1+0.8, and feature_finance and economics=1+0.5;

2) It is hypothesized that among the 800 thousand people that often watch “sports” classification, 600 thousand people often watch football and 400 thousand people often watch basketball, then feature_football=1+0.75 and feature_basketball=1+0.5, thus a weight may be obtained according to the classification in the classification tree;

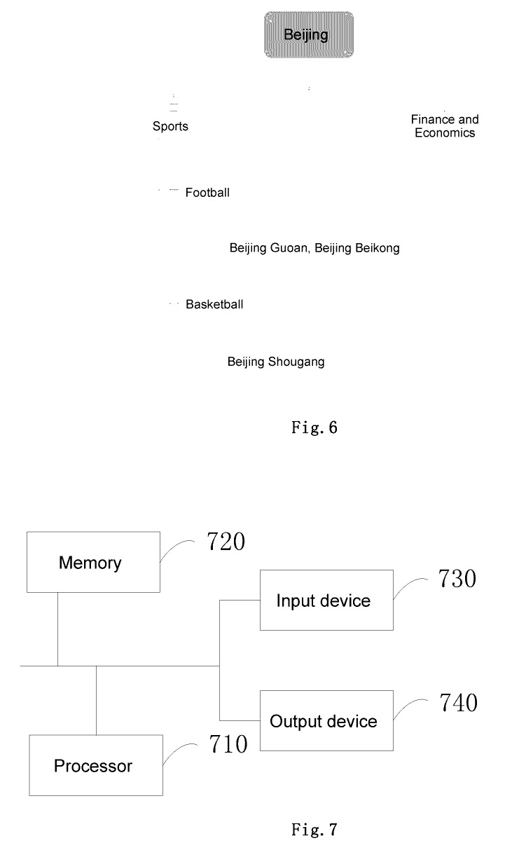

3) It is hypothesized that, as shown in FIG. 6, 400 thousand people watch Beijing Guoan, 200 thousand people watch Beijing Beikong, and 400 thousand people watch Beijing Shougang, then for the first-level classification of sports, there exist three second-level classifications under Beijing Sports according to the existing classification system; it should be noted that, the classification system is designed in advance, and the features (for example, Beijing Guoan and Beijing Beikong, etc.) under the classification system are obtained via data mining; thus, it may be obtained that:

feature_Beijing Guoan=(1+0.75)*(1+0.67)=2.92,

feature_Beijing Beikong=(1+0.75)*(1+0.33)=2.32,

feature_Beijing Shougang=(1+0.5)*(1+1)=3;

4) Thus, the feature vector of object “Beijing City” trained are as follows: in sports channel, feature_Beijing Shougang=3, feature_Beijing Guoan=2.92, and feature_Beijing Beikong=2.32.

Generally, the weight of the first-level classification only acts on a new user, and the subclassification thereunder only acts on a specific channel. For example, an initial page will not act on an older user, but when the older user clicks and enters channel “sports”, the subclassification weight under sports starts to act. It is hypothesized that the old user often watches sport media data and many contents are related to football, then the recommendation system will drop many alternative media data in an inverted index for the user, and process scoring is performed after some other scoring processes. For example, various media data are selected for alternative use, and media data related to feature_Beijing Shougang and feature_Beijing Guoan, etc., and the alternative data will be weighted inevitable after scoring on object “Beijing”.

For the above example, it should be noted that:

1) Here, feature_Beijing Guoan and feature_Beijing Shougang are both watched by 400 thousand people, but they have different weight values, this is because a weight value can be set via percentage of people number to highlight the intensity of group interest better;

2) By determining the feature vector of a regional object in a ready-made mode of classification tree+data mining, overfitting may be prevented well, thus the influence of noise feature data on the effective data may be avoided effectively.

Alternatively, in some implementation, the step 107 of performing regional information scoring on each media data in the alternative media data group by utilizing the regional feature vector related to the location information of the user may further includes the steps of:

A feature vector of each media data is obtained;

A cosine similarity between the feature vector of each media data and the regional feature vector is calculated respectively; and

The regional information score of each media data is represented through the cosine similarity obtained.

Wherein, cosine similarity is also called cosine similitude, the similarity between two vectors is evaluated by calculating the cosine value of the included angle therebetween; this cosine value may be used for representing the similitude between the two vectors; the less the included angle is, the more the cosine value will approach 1, and the more anastomotic their directions will be, and hence the larger the cosine similarity will be.

Alternatively, in some optional implementation, the step 104 of grasping a plurality of media data related to an interest of the target user from a media database may further include the steps of:

Preset character scoring and sequencing are performed on the media data in the media database based on channel character to which each media data belongs; and

The media data are grasped according to the order of the character scores of the media data.

The channel character refers to a special attribute that a specific channel has, and includes the time nodes of some hot spot events of the channel that a target user watches. For example, if it is a sports channel, the time nodes of the hot spot events of this channel may be the World Cup and the Olympic Games, etc.; if it is an information channel, the time nodes of the hot spot events of this channel may be some domestic important conferences and international warfare (Syria problem, etc.). However, this needs to be recommended cooperatively from the historical behaviors of the target user and the hot spots of the current channel, for example, if the target user likes to watch football in normal time, media data related to the World Cup will be weighted on the sports channel and recommended to the user with high priority when the World Cup and the Olympic Games start simultaneously.

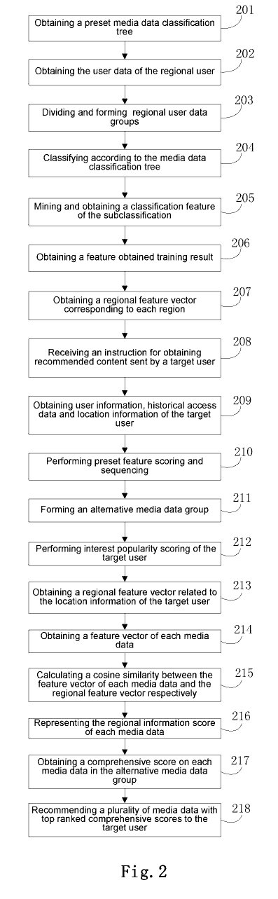

As shown in FIG. 2, it is a schematic flow chart of another embodiment of the method for recommending media data according to the disclosure.

The method for recommending media data includes the steps of:

In step 201: a preset media data classification tree is obtained;

In step 202: the user information and the historical access data of the regional user are obtained;

In step 203: the user information and the historical access data of the regional user are divided according to regions to form regional user data groups;

In step 204: the media data in the regional user data group is classified according to the media data classification tree;

In step 205: a classification feature of the lowest subclassification from the media data of the each lowest subclassification is mined and obtained via a cluster algorithm;

In step 206: a feature obtained training result is obtained by combining the media data classification tree with the classification feature of the each lowest subclassification thereof;

In step 207: a regional feature vector corresponding to each region is obtained from the feature obtained training result generated;

In step 208: an instruction for obtaining recommended content sent by a certain target user is received;

In step 209: user information, historical access data and location information of the target user are obtained;

In step 210: preset character scoring and sequencing on the media data in the media database are performed based on channel character to which each media data belongs;

In step 211: a plurality of media data related to an interest of the target user are grasped from the media database in the order of the character scores of the media data according to the historical access data of the target user to form an alternative media data group;

In step 212: interest popularity scoring of the target user is performed on each media data in the alternative media data group according to the historical access data of the target user;

In step 213: a regional feature vector related to the location information of the target user is obtained according to the location information of the target user;

In step 214: a feature vector of each media data is obtained;

In step 215: a cosine similarity between the feature vector of each media data and the regional feature vector is calculated respectively;

In step 216: the regional information score of each media data is represented with the cosine similarity obtained;

In step 217: a comprehensive score on each media data in the alternative media data group is obtained by combining the interest popularity score of the target user with the regional information score; and

In step 218: a plurality of media data with top ranked comprehensive scores are recommended to the target user.

It may be seen from the above embodiment that, in the method for recommending media data according to the embodiment of the disclosure, first of all, regional users are divided according to regions, a regional feature vector is obtained based on the user data in the region, the corresponding media data is grasped based on the historical access data of the target user when an instruction for obtaining recommended content sent by a certain user is received, target user interest hot spot scoring is performed on these media data, the corresponding regional feature vector is obtained according to the location information of the target user, the regional information score is calculated, a comprehensive score is obtained by combining the two kinds of scores, and media data are recommended to the target user according to the sequencing of comprehensive scores. Therefore, when media data are recommended to the target user, the media data can not only be recommended according to the interest hot spot of the target user, but also be recommended in conjunction with the group hot spot of the region in which the target user locates, thereby the effect of more accurately recommending media data to a target user may be realized. Additionally, by determining the feature vector of a regional object in a ready-made mode of classification tree+data mining, overfitting may be well prevented, thus the influence of noise feature data on the effective data may be avoided effectively.

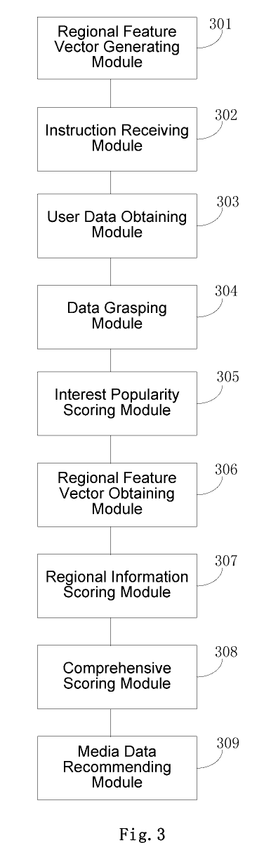

In another aspect of the embodiment of the disclosure, there further provides a server for recommending media data, by which a specific user can be well recommended with media data that may better meet the real demand thereof. As shown in FIG. 3, it is a schematic diagram showing the module structure of an embodiment of the server for recommending media data according to the disclosure.

The server for recommending media data includes: a regional feature vector generating module 301, an instruction receiving module 302, a user data obtaining module 303, a data grasping module 304, an interest popularity scoring module 305, a regional feature vector obtaining module 306, a regional information scoring module 307, a comprehensive scoring module 308 and a media data recommending module 309.

The regional feature vector generating module 301 generates a regional feature vector of each region based on user information and historical access data (the data source is a log) of a regional user.

Here, the user information and the historical access data of the regional user refer to the user information and the historical access data of nationwide users; the region generally refers to a prefecture city-level region, of course, it may be a county-level city or a county, but the statistical meaning of county is very small, and it is statistically enough for prefecture city; the regional feature vector refers to a vector including a plurality of features representing the interest hot spot of the users in this region that may be statistically obtained from the user group in this region; the regional feature vector embodies the tendency attributes and weights of some interests in each region, and the value in each regional feature vector is usually different, which embodies an aggregation of people's interests in each region.

The instruction receiving module 302 receives an instruction for obtaining recommended content sent by a target user; that is, a certain target user opens a certain portal web site (or a lower-level classification menu thereof, for example, football) or a certain video player software (or a lower-level classification menu thereof, for example, football), because a homepage or a lower-level menu page needs to be exhibited, an instruction for obtaining recommended content is sent to the server, and the instruction is received by the server.

The user data obtaining module 303 obtains user information, historical access data and location information of the target user after the instruction for obtaining recommended content sent by a certain target user is received; wherein, the user information includes target user ID, target user level (VIP or not), etc., the historical access data includes the near-term watching and viewing records of the target user, the location information is the current geographic location of the target user, the location information may be obtained via the IP address of the computer of the user or the GPS positioning of the mobile phone of the target user, etc.

The data grasping module 304 grasps a plurality of media data related to an interest of the target user from a media database according to the historical access data of the target user to form an alternative media data group.

Wherein, a plurality of near-term interest hot spots (for example, football and American film and play, etc.) of the target user can be statistically obtained from the historical access data of the target user, media data related to the corresponding interest hot spot may be grasped from the media database according to each interest hot spot, and the number of media data grasped for each interest hot spot is in a range of 50˜500, and usually about 200; and the media data groups grasped based on each interest hot spot are synthesized into the alternative media data group.

The interest popularity scoring module 305 performs interest popularity scoring of the target user on each media data in the alternative media data group according to the historical access data of the target user.

That is, different popularity of each interest hot spot of the target user is obtained according to the historical access data of the target user, for example, in the past 30 days, the target user browsed the classification “football” for 40 times and browsed classification “American film and play” for 20 times, then the popularity of “football” is about twice of the popularity of “American film and play”. However, this is only an example, the popularity may also be calculated via staged popularity calculation according to the time at which the interest hot spot appears (for example, media data appearing at a time far from the current time will be de-weighted over time), etc., then the interest popularity score of the target user of each media data is obtained according to the popularity.

The regional feature vector obtaining module 306 obtains a regional feature vector related to the location information of the target user according to the location information of the target user; for example, the current location information of the target user is a certain building in Zhongguancun, Haidian District, Beijing City, then the regional feature vector corresponding thereto will be the regional feature vector corresponding to Beijing City.

The regional information scoring module 307 performs regional information scoring on each media data in the alternative media data group by utilizing the regional feature vector related to the location information of the target user; that is, a similarity between the feature vector of the media data and the regional feature vector is calculated, and a regional information score is obtained via the similarity.

The comprehensive scoring module 308 obtains a comprehensive score on each media data in the alternative media data group by combining the interest popularity score of the target user with the regional information score.

The media data recommending module 309 recommends a plurality of media data with top ranked comprehensive scores to the target user.

It may be seen from the above embodiment that, in the server for recommending media data according to the embodiment of the disclosure, first of all, regional users are divided according to regions, a regional feature vector is obtained based on the user data in the region, the corresponding media data is grasped based on the historical access data of the target user when an instruction for obtaining recommended content sent by a certain target user is received, target user interest hot spot scoring is performed on these media data, the corresponding regional feature vector is obtained according to the location information of the target user, a regional information score is calculated, a comprehensive score is obtained by combining the two kinds of scores, and media data are recommended to the target user according to the sequencing of a comprehensive scores. Therefore, when media data are recommended to the target user, the media data can not only be recommended according to the interest hot spot of the target user, but also be recommended in conjunction with the group hot spot of the region in which the target user locates, thereby the effect of more accurately recommending media data to the target user may be realized.

For each region (for example, Beijing City), it is regarded as a special object, this object has some basic features, and the information of this region is described via a feature vector. The features that “Beijing City” has are not simply set manually; it is a model trained commonly according to a classification system and data mining based on all user data in Beijing.

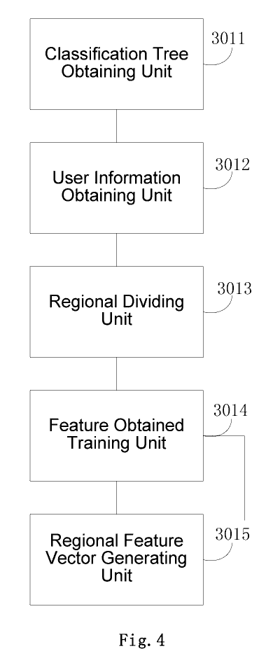

Therefore, as shown in FIG. 4, in some optional implementation, the regional feature vector generating module 301 may further include: a classification tree obtaining unit 3011, a user information obtaining unit 3012, a regional dividing unit 3013, a feature obtained training unit 3014 and a regional feature vector generating unit 3015.

The classification tree obtaining unit 3011 obtains a preset media data classification tree (a structure chart of the classification tree comes from a preset configuration file); wherein, the media data classification tree is set in advance, and the subclassification such as lower-level classification and next lower-level classification, etc., is set in advance; as shown in FIG. 5, it is hypothesized that media data classification tree includes sports, finance and economics and music as first-level classification (that is, channel, and the weight value of the first-level classification only acts on a new user), and sports has football, basketball and F1 as second-level classification.

The user information obtaining unit 3012 obtains the user information and the historical access data of the regional user.

The regional dividing unit 3013 divides the user information and the historical access data of the regional user according to regions to form regional user data groups.

The feature obtained training unit 3014 performs feature obtained training on each regional user data group respectively according to the structure of the media data classification tree.

The regional feature vector generating unit 3015 obtains a regional feature vector corresponding to each region from the feature obtained training result generated.

By performing feature obtained training via the structure of the media data classification tree, overfitting can be well prevented, thus the influence of noise feature data on the effective data may be avoided effectively.

Moreover, in some implementation, the feature obtained training unit 3014 further classifies the media data in the regional user data group according to the media data classification tree (that is, first of all, assigns the media data to each classification of the media data classification tree corresponding to the feature thereof; this step may prevent overfitting well by preliminarily pre-classifying the media data); mines and obtains a classification feature of the lowest subclassification from the media data of the each lowest subclassification via a cluster algorithm (because the media data classification tree only includes a preliminary classification structure, the specific features therein need to be mined via a cluster algorithm); and obtains a feature obtained training result by combining the media data classification tree with the classification feature of each lowest subclassification thereof.

Wherein, according to the results of classifying and clustering, the weight of the corresponding feature may also be obtained. The process of feature obtained training will be introduced below via an example:

1) It is hypothesized that “Beijing City” contains 1 million people and these people only watch two types of media data, among these 1 million people, 800 thousand people often watch sports-type media data and 500 thousand people often watch finance and economics-type media data (wherein, 300 thousand people watch both); by data analysis, the features of the object “Beijing” may be divided into two major classifications (sports, finance and economics), and it may be obtained that: feature_sports=1+0.8, and feature_finance and economics=1+0.5;

2) It is hypothesized that among the 800 thousand people that often watch “sports” classification, 600 thousand people often watch football and 400 thousand people often watch basketball, then feature_football=1+0.75 and feature_basketball=1+0.5, thus a weight may be obtained according to the classification in the classification tree;

3) It is hypothesized that, as shown in FIG. 6, 400 thousand people watch Beijing Guoan, 200 thousand people watch Beijing Beikong, and 400 thousand people watch Beijing Shougang, then for the first-level classification of sports, there exist three second-level classifications under Beijing Sports according to the existing classification system; it should be noted that, the classification system is designed in advance, and the features (for example, Beijing Guoan and Beijing Beikong, etc.) under the classification system are obtained via data mining; it may be obtained that:

feature_Beijing Guoan=(1+0.75)*(1+0.67)=2.92,

feature_Beijing Beikong=(1+0.75)*(1+0.33)=2.32,

feature_Beijing Shougang=(1+0.5)*(1+1)=3;

4) Thus, the feature vector of object “Beijing City” trained are as follows: in sports channel, feature_Beijing Shougang=3, feature_Beijing Guoan=2.92, and feature_Beijing Beikong=2.32.

Generally, the weight of the first-level classification only acts on a new user, and the subclassification thereunder only acts on a specific channel. For example, an initial page will not act on an older user, but when the older user clicks and enters channel “sports”, the subclassification weight under sports starts to act. It is hypothesized that the old user often watches sport media data and many contents are related to football, then the recommendation system will drop many alternative media data in an inverted index for the user, and process scoring is performed after some other scoring processes. For example, various media data are selected for alternative use, and after scoring on object “Beijing”, media data related to feature_Beijing Shougang and feature_Beijing Guoan, etc., and the alternative data will be weighted inevitably.

For the above example, it should be noted that:

1) Here, feature_Beijing Guoan and feature_Beijing Shougang are both watched by 400 thousand people, but they have different weight values, this is because a weight value is set via percentage of people number to highlight the intensity of group interest better; and

2) By determining the feature vector of a regional object in a ready-made mode of classification tree+data mining, overfitting may be prevented well, thus the influence of noise feature data on the effective data may be avoided effectively.

Alternatively, in some implementation, the regional information scoring module 307 further obtains a feature vector of each media data; calculates a cosine similarity between the feature vector of each media data and the regional feature vector respectively, and represents the regional information score of each media data through the cosine similarity obtained.

Wherein, cosine similarity is also called cosine similitude, the similarity between two vectors is evaluated by calculating the cosine value of the included angle therebetween; this cosine value may be used for representing the similitude between the two vectors; the less the included angle is, the more the cosine value will approach 1, and the more anastomotic their directions will be, and hence the larger the cosine similarity will be.

Alternatively, in some optional implementation, the data grasping module 304 further performs preset character scoring and sequencing on the media data in the media database based on channel character to which each media data belongs, and grasps the media data according to the order of the character scores of the media data.

The channel character refers to a special attribute that a specific channel has, and includes the time nodes of some hot spot events of the channel that a target user watches. For example, if it is a sports channel, the time nodes of the hot spot events of this channel may be the World Cup and the Olympic Games, etc.; if it is an information channel, the time nodes of the hot spot events of this channel may be some domestic important conferences and international warfare (Syria problem, etc.). However, this needs to be recommended cooperatively from the historical behaviors of the target user and the hot spots of the current channel, for example, if the target user likes to watch football in normal time, media data related to the World Cup will be weighted on the sports channel and recommended to the user with high priority when the World Cup and the Olympic Games start simultaneously.

Another embodiment of the method for recommending media data implementing the server for recommending media data according to the embodiment of the disclosure will be introduced below in conjunction with FIG. 2.

The method for recommending media data includes the following steps.

In step 201: the classification tree obtaining unit 3011 obtains a preset media data classification tree.

In step 202: the user information obtaining unit 3012 obtains the user information and the historical access data of the regional user.

In step 203: the regional dividing unit 3013 divides the user information and the historical access data of the regional user according to regions to form regional user data groups.

In step 204: the feature obtained training unit 3014 classifies the media data in the regional user data group according to the media data classification tree.

In step 205: the feature obtained training unit 3014 mines and obtains a classification feature of the lowest subclassification from the media data of the each lowest subclassification via a cluster algorithm.

In step 206: the feature obtained training unit 3014 obtains a feature obtained training result by combining the media data classification tree with the classification feature of each lowest subclassification thereof.

In step 207: the regional feature vector generating unit 3015 obtains a regional feature vector corresponding to each region from the feature obtained training result generated.

In step 208: the instruction receiving module 302 receives an instruction for obtaining recommended content sent by a certain target user.

In step 209: the user data obtaining module 303 obtains user information, historical access data and location information of the target user.

In step 210: the data grasping module 304 performs preset character scoring and sequencing on the media data in the media database based on channel character to which each media data belongs.

In step 211: the data grasping module 304 grasps a plurality of media data related to an interest of the target user from the media database in the order of the character scores of the media data according to the historical access data of the target user to form an alternative media data group.

In step 212: the interest popularity scoring module 305 performs interest popularity scoring of the target user on each media data in the alternative media data group according to the historical access data of the target user.

In step 212: the regional feature vector obtaining module 306 obtains a regional feature vector related to the location information of the target user according to the location information of the target user.

In step 213: the regional information scoring module 307 obtains a feature vector of each media data.

In step 214: the regional information scoring module 307 calculates a cosine similarity between the feature vector of each media data and the regional feature vector respectively.

In step 215: the regional information scoring module 307 represents the regional information score of each media data through the cosine similarity obtained.

In step 216: the comprehensive scoring module 308 obtains a comprehensive score on each media data in the alternative media data group by combining the interest popularity score of the target user with the regional information score.

In step 217: the media data recommending module 309 recommends a plurality of media data with top ranked comprehensive scores to the target user.

It may be seen from the above embodiment that, in the server for recommending media data according to the embodiment of the disclosure, first of all, regional users are divided according to regions, a regional feature vector is obtained based on the user data in the region, the corresponding media data is grasped based on the historical access data of the target user when an instruction for obtaining recommended content sent by a certain target user is received, target user interest hot spot scoring is performed on these media data, the corresponding regional feature vector is obtained according to the location information of the target user, the regional information score is calculated, a comprehensive scores is obtained by combining the two kinds of scores, and media data are recommended to the target user according to the sequencing of comprehensive scores. Therefore, when media data are recommended to the target user, the media data can not only be recommended according to the interest hot spot of the target user, but also be recommended in conjunction with the group hot spot of the region in which the target user locates, thereby the effect of more accurately recommending media data to a target user may be realized. Additionally, by determining the feature vector of a regional object in a ready-made mode of classification tree+data mining, overfitting may be prevented well, thus the influence of noise feature data on the effective data may be avoided effectively.

The embodiments of the present disclosure further provide a non-volatile computer-readable storage medium, the non-volatile computer-readable storage medium is stored with computer executable instructions, the computer executable instructions perform the method described above in any embodiment described above.

FIG. 7 is a schematic diagram of structure of an electronic device performing the method described above according to an embodiment of the present disclosure, as shown in FIG. 7, the device includes:

One or more processors 710 and a memory 720, FIG. 7 illustrates one processor 710 as an example.

The device for the method described above may further include an input device 430 and an output device 740.

The processor 710, the memory 720, the input device 730 and the output device 740 may be connected with each other through bus or other forms of connections. FIG. 7 illustrates bus connection as an example.

As a non-volatile computer-readable storage medium, the memory 720 may store non-volatile software program, non-volatile computer executable program and modules, such as program instructions/modules corresponding to the method described above according to the embodiments of the disclosure (for example, a regional feature vector generating module 301, an instruction receiving module 302, a user data obtaining module 303, a data grasping module 304, an interest popularity scoring module 305, a regional feature vector obtaining module 306, a regional information scoring module 307, a comprehensive scoring module 308 and a media data recommending module 309, as illustrated in FIG. 3. By executing the non-volatile software program, instructions and modules stored in the memory 720, the processor 710 may perform various functional applications of the server and data processing, that is, the method described above according to the above mentioned embodiments.

The memory 720 may include a program storage area and a data storage area, wherein, the program storage area may be stored with the operating system and applications which are needed by at least one functions, and the data storage area may be stored with data which is created according to use of the device described above. Further, the memory 720 may include a high-speed random access memory, and may further include non-volatile memory, such as at least one of disk memory device, flash memory device or other types of non-volatile solid state memory device. In some embodiments, optionally, the memory 720 may include memory provided remotely from the processor 710, and such remote memory may be connected with the server for recommending media data through network connections, the examples of the network connections may include but not limited to internet, intranet, LAN (Local Area Network), mobile communication network or combinations thereof.

The input device 730 may receive inputted number or character information, and generate key signal input related to the user settings and functional control of server for recommending media data. The output device 740 may include a display device such as a display screen.

The above one or more modules may be stored in the memory 720, when these modules are executed by the one or more processors 710, the method for recommending media data according to any one of method-type embodiments described above may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) Mobile communication device, characterized in having a function of mobile communication mainly aimed at providing speech and data communication, wherein such terminal includes: smart phone (such as iPhone), multimedia phone, functional phone, low end phone and the like;

(2) Ultra mobile personal computer device, which falls in a scope of personal computer, has functions of calculation and processing, and generally has characteristics of mobile internet access, wherein such terminal includes: PDA, MID and UMPC devices, such as iPad;

(3) Portable entertainment device, which can display and play multimedia contents, and include audio or video player (such as iPod), portable game console, E-book and smart toys and portable vehicle navigation device;

(4) Server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) Other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for recommending media data, which is applied to an electronic device, comprising:
generating a regional feature vector of each region based on user information and historical access data of a regional user;
receiving an instruction for obtaining recommended content sent by a target user;
obtaining user information, historical access data and location information of the target user;
grasping a plurality of media data related to an interest of the target user from a media database according to the historical access data of the target user to form an alternative media data group;
performing interest popularity scoring of the target user on media data in the alternative media data group according to the historical access data of the target user;
obtaining a regional feature vector related to the location information of the target user according to the location information of the target user;
performing regional information scoring on the media data in the alternative media data group by utilizing the regional feature vector related to the location information of the target user;
obtaining a comprehensive score of the media data in the alternative media data group by combining the interest popularity score of the target user with the regional information score; and
recommending a plurality of media data with top ranked comprehensive scores to the target user.

2. The method according to claim 1, wherein, the step to generate a regional feature vector of each region based on user information and historical access data of a regional user comprises:
obtaining a preset media data classification tree;
obtaining the user information and the historical access data of the regional user;
dividing the user information and the historical access data of the regional user according to regions to form regional user data groups;
performing feature obtained training on each regional user data group respectively according to structure of the media data classification tree; and
obtaining the regional feature vector corresponding to the each region from the feature obtained training result generated.

3. The method according to claim 2, wherein, the step to train each regional user data group respectively according to structure of the media data classification tree comprises:
classifying media data in the regional user data group according to the media data classification tree;
mining and obtaining, from media data of each lowest subclassification, a classification feature of the lowest subclassification via a cluster algorithm; and
obtaining the feature obtained training result by combining the media data classification tree with the classification feature of the lowest subclassification.

4. The method according to claim 1, wherein, the step to perform regional information scoring on the media data in the alternative media data group by utilizing the regional feature vector related to the location information of the target user comprises:
obtaining a feature vector of the media data in the alternative media data group;
calculating a cosine similarity between the feature vector of the media data and the regional feature vector; and
representing the regional information score of the media data with the cosine similarity obtained.

5. The method according to claim 1, wherein, the step to grasp a plurality of media data related to an interest of the target user from the media database comprises:
performing preset character scoring and sequencing on the media data in the media database based on channel character to which the media data belongs; and
grasping the media data according to an order of character scores of the media data.

6. A non-volatile computer-readable storage medium stored with computer executable instructions that, when executed by an electronic device, cause the electronic device to:
generate a regional feature vector of each region based on user information and historical access data of a regional user;
receive an instruction for obtaining recommended content sent by a target user;
obtain user information, historical access data and location information of the target user;
grasp a plurality of media data related to an interest of the target user from a media database according to the historical access data of the target user to form an alternative media data group;
perform interest popularity scoring of the target user on media data in the alternative media data group according to the historical access data of the target user;
obtain a regional feature vector related to the location information of the target user according to the location information of the target user;
perform regional information scoring on the media data in the alternative media data group by utilizing the regional feature vector related to the location information of the target user;
obtain a comprehensive score of the media data in the alternative media data group by combining the interest popularity score of the target user with the regional information score; and
recommend a plurality of media data with top ranked comprehensive scores to the target user.

7. The non-volatile computer-readable storage medium according to claim 6, wherein, the step to generate a regional feature vector of each region based on user information and historical access data of a regional user comprises:
obtaining a preset media data classification tree;
obtaining the user information and the historical access data of the regional user;
dividing the user information and the historical access data of the regional user according to regions to form regional user data groups;
performing feature obtained training on each regional user data group respectively according to structure of the media data classification tree; and
obtaining the regional feature vector corresponding to the each region from the feature obtained training result generated.

8. The non-volatile computer-readable storage medium according to claim 7, wherein, the step to train each regional user data group respectively according to structure of the media data classification tree comprises:
classifying media data in the regional user data group according to the media data classification tree;
mining and obtaining, from media data of each lowest subclassification, a classification feature of the lowest subclassification via a cluster algorithm; and
obtaining the feature obtained training result by combining the media data classification tree with the classification feature of the lowest subclassification.

9. The non-volatile computer-readable storage medium according to claim 6, wherein, the step to perform regional information scoring on the media data in the alternative media data group by utilizing the regional feature vector related to the location information of the target user comprises:
obtaining a feature vector of the media data in the alternative media data group;
calculating a cosine similarity between the feature vector of the media data and the regional feature vector; and
representing the regional information score of the media data with the cosine similarity obtained.

10. The non-volatile computer-readable storage medium according to claim 6, wherein, the step to grasp a plurality of media data related to an interest of the target user from the media database comprises:
performing preset character scoring and sequencing on the media data in the media database based on channel character to which the media data belongs; and
grasping the media data according to an order of character scores of the media data.

11. An electronic device, comprising:
at least one processor; and
a memory, communicably connected with the at least one processor for storing instructions executed by the at least one processor,
wherein execution of the instructions by the at least one processor causes the at least one processor to:
generate a regional feature vector of each region based on user information and historical access data of a regional user;
receive an instruction for obtaining recommended content sent by a target user;
obtain user information, historical access data and location information of the target user;
grasp a plurality of media data related to an interest of the target user from a media database according to the historical access data of the target user to form an alternative media data group;
perform interest popularity scoring of the target user on media data in the alternative media data group according to the historical access data of the target user;
obtain a regional feature vector related to the location information of the target user according to the location information of the target user;
perform regional information scoring on the media data in the alternative media data group by utilizing the regional feature vector related to the location information of the target user;
obtain a comprehensive score of the media data in the alternative media data group by combining the interest popularity score of the target user with the regional information score; and
recommend a plurality of media data with top ranked comprehensive scores to the target user.

12. The electronic device according to claim 11, wherein, the step to generate a regional feature vector of each region based on user information and historical access data of a regional user comprises:
obtaining a preset media data classification tree;
obtaining the user information and the historical access data of the regional user;
dividing the user information and the historical access data of the regional user according to regions to form regional user data groups;
performing feature obtained training on each regional user data group respectively according to structure of the media data classification tree; and
obtaining the regional feature vector corresponding to the each region from the feature obtained training result generated.

13. The electronic device according to claim 12, wherein, the step to train each regional user data group respectively according to structure of the media data classification tree comprises:
classifying media data in the regional user data group according to the media data classification tree;
mining and obtaining, from media data of each lowest subclassification, a classification feature of the lowest subclassification via a cluster algorithm; and
obtaining the feature obtained training result by combining the media data classification tree with the classification feature of the lowest subclassification.

14. The electronic device according to claim 11, wherein, the step to perform regional information scoring on the media data in the alternative media data group by utilizing the regional feature vector related to the location information of the target user comprises:
obtaining a feature vector of the media data in the alternative media data group;
calculating a cosine similarity between the feature vector of the media data and the regional feature vector; and
representing the regional information score of the media data with the cosine similarity obtained.

15. The electronic device according to claim 11, wherein, the step to grasp a plurality of media data related to an interest of the target user from the media database comprises:
performing preset character scoring and sequencing on the media data in the media database based on channel character to which the media data belongs; and
grasping the media data according to an order of character scores of the media data.
